(19) United States
(12) Patent Application Publication
(10) Pub. No.: US 2011/0003120 A1
(43) Pub. Date: Jan. 6, 2011

(54) WORKPIECE TO BE WELDED AND WELDED PRODUCT

(75) Inventor: BIN DAI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (shenZhen) CO., LTD., Shenzhen City (CN); HON HAI PRECISION INDUSTRY CO., LTD., Tu-Cheng (TW)

(21) Appl. No.: 12/605,453

(22) Filed: Oct. 26, 2009

(30) Foreign Application Priority Data
Jul. 6, 2009 (CN) 200910304030.0

(51) Int. Cl. B32B 3/30

(52) U.S. Cl. 428/156

(57) ABSTRACT

The present disclosure provides a workpiece and a welded product. The welded product includes the workpiece. The workpiece includes a welded region, an edge, and a stress releasing slot. The stress releasing slot is adjacent to the welded region, and ends of the stress releasing slot intersect the edge. In the welded product, stress can be released via the stress releasing slot.

### BACKGROUND

1. Technical Field

The present disclosure generally relates to workpieces and welded products, and particularly, to a workpiece to be welded and a product formed from the workpiece.

2. Description of Related Art

Internal stress is frequently generated in a welded region of a welded product due to the increased temperature of the welded region. Such internal stress can result in product deformity, and affect aesthetic appeal and performance, such as mechanism performance.

Such products are often rolled to restore a desired shape. However, if the welded region of the product is not flat, for example, curved or in a corner, the rolling method is difficult to apply.

Therefore, a workpiece to be welded and a welded product are desired to overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of an embodiment of a welded product as disclosed, including a first workpiece and a second workpiece, also as disclosed.

FIG. 2 is an isometric view showing the first workpiece of FIG. 1 before being welded to the second workpiece.

FIG. 3 is a cross-section of the welded product of FIG. 1.

FIG. 4 is an enlarged view of part IV of FIG. 3.

### DETAILED DESCRIPTION

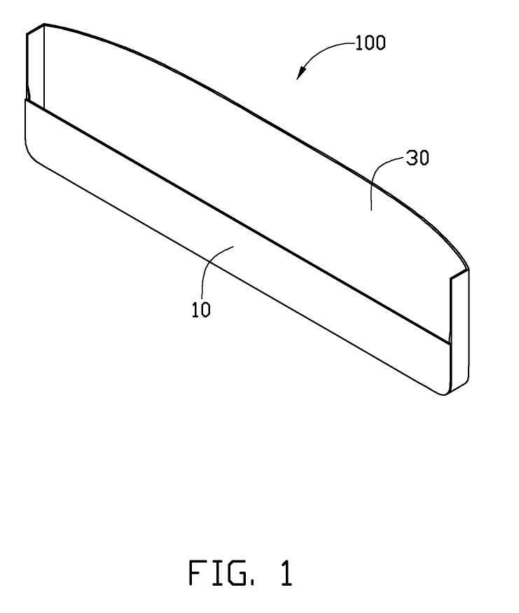

Referring to FIG. 1, an embodiment of a welded product 100 includes a first workpiece 10 and a second workpiece 30 to be welded together.

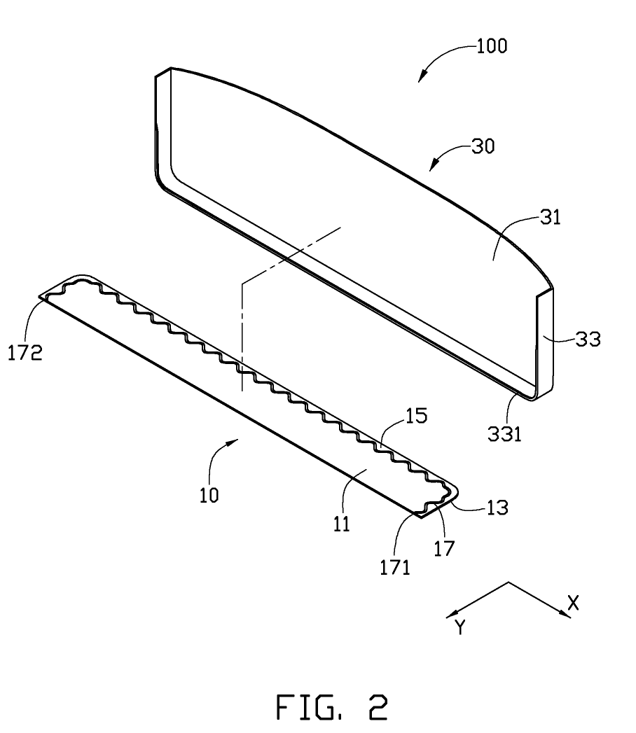

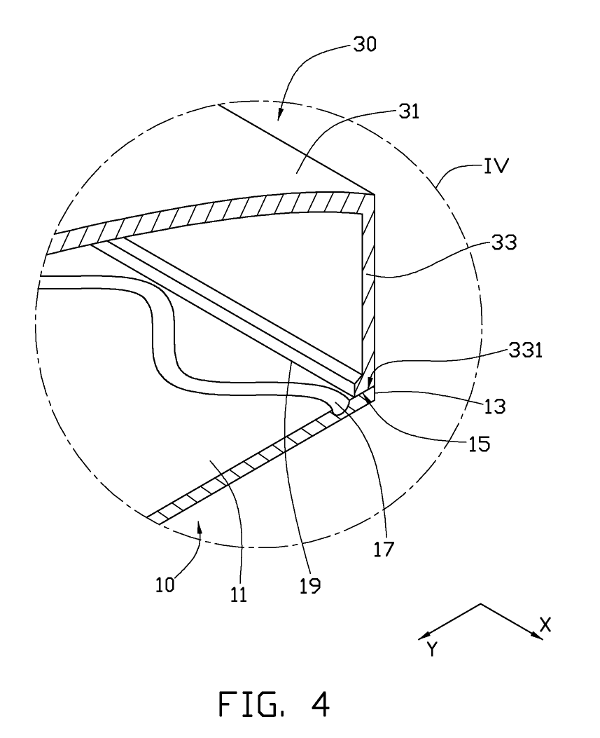

Referring to FIG. 2, the first workpiece 10 includes a welding surface 11, an edge 13, and a welded region 15. The first workpiece 10 further defines a stress releasing slot 17. The welded region 15 is adjacent to the edge 13, and the stress releasing slot 17 is adjacent to the welded region 15. The stress releasing slot 17 continuously and curvingly extends in the welding surface 11. The stress releasing slot 17 has a depth less than a thickness of the first workpiece 10, and two ends 171, 172 of the stress releasing slot 17 intersect with the edge 13. As shown in FIG. 4, the stress releasing slot 17 has a cross-section with a curved contour. In the illustrated embodiment, the stress releasing slot 17 extends along an irregular, curved path line and has a curved cross-section. Alternatively, the stress releasing slot 17 may be zigzagged.

The second workpiece 30 is a housing including a rear sheet 31 and a flange 33 extending from an edge of the rear sheet 31. The flange 33 includes a connecting surface 331.

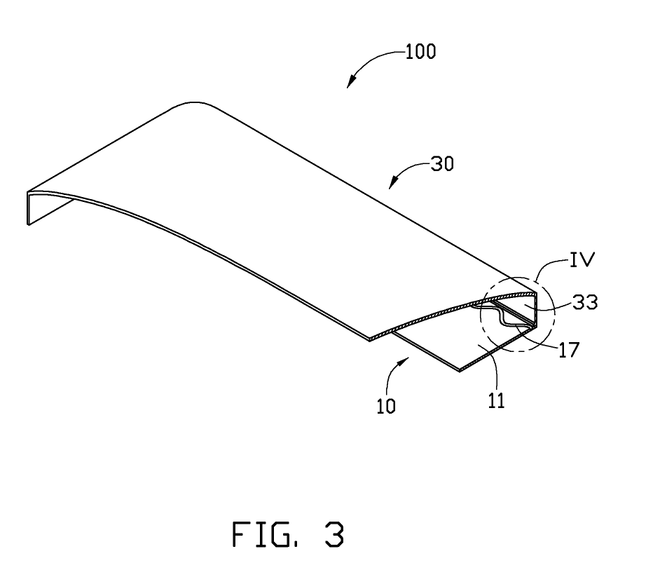

Referring to FIG. 2 through FIG. 4, with the welding surface 11 facing the rear sheet 31, the edge 13 is connected to the connecting surface 331 of the flange 33, thus the first workpiece 10 is welded to the second workpiece 30. After welding, a seam 19 adjacent to the stress releasing slot 17 is formed.

In the illustrated embodiment, the first workpiece 10 has a thickness less than the second workpiece 30 resulting in the first workpiece 10 being easier to deform, therefore the stress releasing slot 17 is defined in the first workpiece 10.

In the welded product 100, stress can be released via the stress releasing slot 17 because the stress releasing slot 17 is adjacent to the seam 19. Because, the stress releasing slot 17 continuously extends in the welding surface 11 and along the welded region 15, such that stress in any position of the welded region 15 can be released. Further, because the stress releasing slot 17 is curved, stress in any direction can be released. Furthermore, stress may be fully released by ends 171, 172 of the stress releasing slot 17 intersecting with the edge 13.

Alternatively, the stress releasing slot 17 may be defined in the second workpiece 30.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A workpiece, comprising:
a welded region;
an edge; and
a stress releasing slot adjacent to the welded region, wherein ends of the stress releasing slot intersect with the edge.

2. The workpiece of claim 1, wherein the stress releasing slot extends along the entire welded region and is adjacent to the welded region.

3. The workpiece of claim 1, wherein a depth of the stress releasing slot is less than a thickness of the workpiece.

4. The workpiece of claim 1, wherein the stress releasing slot is continuous and curved.

5. The workpiece of claim 4, wherein the stress releasing slot is a smooth curve.

6. The workpiece of claim 1, wherein the stress releasing slot is irregularly shaped.

7. The workpiece of claim 1, wherein the stress releasing slot is zigzagged.

8. The workpiece of claim 1, wherein the stress releasing slot has a cross-section with a curved contour.

9. The workpiece of claim 1, wherein the welded region is adjacent to the edge.

10. A welded product, comprising:
a first workpiece defining a stress releasing slot;
a second workpiece welded to the first workpiece;
wherein a seam is formed between the first workpiece and the second workpiece, and the stress releasing slot extends adjacent to the seam to release stress generated during welding of the first workpiece and the second workpiece, and the ends of the stress releasing slot intersect with an edge of the first workpiece.

11. The product of claim 10, wherein the stress releasing slot is continuous and curved.

12. The product of claim 10, wherein the stress releasing slot is zigzagged.

13. A welded product, comprising:
a first workpiece defining a stress releasing slot;
a second workpiece welded to the first workpiece;
wherein a seam is formed between the first workpiece and the second workpiece, stress generated along the seam during welding of the first workpiece and the second workpiece and is transferred to the stress releasing slot, causing the stress to be transferred to an edge of the first workpiece via the stress releasing slot.

14. The product of claim 13, wherein the ends of the stress releasing slot intersect an edge of the first workpiece.

15. The product of claim 13, wherein the stress releasing slot is continuous and curved.

16. The product of claim 13, wherein the stress releasing slot is zigzagged.
